(19) United States
(12) Patent Application Publication
(10) Pub. No.: US 2023/0141920 A1
(43) Pub. Date: May 11, 2023

(54) COMMISSIONING FREQUENCY CONVERTERS IN ELECTRICAL DRIVE SYSTEMS

(71) Applicant: Lenze SE, Aerzen (DE)

(72) Inventors: Kevin Corcoran, Millis, MA (US); Steven Dextraze, Blackstone, MA (US)

(73) Assignee: Lenze SE, Aerzen (DE)

(21) Appl. No.: 17/981,541

(22) Filed: Nov. 7, 2022

(30) Foreign Application Priority Data
Nov. 9, 2021 (DE) 102021129139.9

(51) Int. Cl. H02K 11/35

(52) U.S. Cl. CPC H02K 11/35; H04W 84/12

(57) ABSTRACT

The system described herein relates to commissioning variable frequency drives of electric drive systems, where at least one variable frequency drive has wireless data transmission equipment via which the variable frequency drive is supplied with data during commissioning. A commissioning device connects with the wireless data transmission equipment of the variable frequency drive during commissioning to transmit data to the variable frequency drive. The wireless data transmission equipment of the variable frequency drive is set up before commissioning so that the variable frequency drive can be communicated with under an individual identifier specific to the respective variable frequency drive and during commissioning identification of the individual variable frequency drive is carried out by the commissioning device using the identifier.

### TECHNICAL FIELD

The system described herein relates to commissioning variable frequency drives of electric drive systems.

### BACKGROUND

Variable frequency drives serve to supply electric motors with electrical energy. To this end, the variable frequency drives convert the alternating voltage provided by an energy supply network into an alternating voltage that is suitable for operating an electric motor. In doing so, in particular, the frequency of the alternating voltage that is supplied to the electric motor is changed in comparison to the alternating voltage provided by the energy supply network.

As well as simply changing the frequency of the voltage, modern variable frequency drives are also able to fulfil complex control and/or regulation tasks. Thus, for example, a change in frequency can result in speed control. For example, it is possible to provide a frequency ramp when starting the electric motor to prevent excess current peaks when starting the electric motor.

### SUMMARY OF THE INVENTION

In some cases, it is necessary to regularly adjust a variable frequency drive according to the operating conditions provided for commissioning in each case. This concerns, in particular, the adaptation of a variable frequency drive to the electric motor that is to be supplied with electrical energy through the variable frequency drive, and/or to the purpose that the electric drive system formed by the variable frequency drive and electric motor is meant to serve. In this context, it can be envisaged that the individual adjustable parameters of the variable frequency drive are set and thus adjusted to the operating conditions; however, also more complex programming may have to be performed on the variable frequency drive when commissioning the variable frequency drive.

For this, the variable frequency drives is supplied with data in the course of commissioning. In order to facilitate supplying data, in particular, a commissioning device is connected to the variable frequency drive. The commissioning device can, for example, be a laptop or a tablet. The commissioning devices facilitate transmission of the data that concerns the parameters and/or programming of the variable frequency drive to the user on site.

To further increase the ease of use of data transmission on site, modern variable frequency drives may also often have wireless data transmission equipment to which the commissioning device can connect. This means that the operator entrusted with the commissioning on site need only be located sufficiently close to the variable frequency drive; a direct manipulation of the variable frequency drive, for example, by creating a cable data connection, is ideally no longer required. There are also advantages in a technical safety respect, as, for example, switch cabinets no longer need to be opened during commissioning. The use of such wireless data transmission equipment also reduces the risk of accidents that may occur during commissioning due to unintended contact with electrical wires by the person carrying out the commissioning.

However, a disadvantage in the use of such wireless data transmission equipment is that there must be an initial identification of the correct wireless data transmission equipment during commissioning. Moreover, the wireless data transmission equipment must be sufficiently secured against unauthorized access.

U.S. Pat. No. 10,389,304 B2 describes a system of variable frequency drives that each have wireless data transmission equipment. The data transmission equipment can therefore connect to each other via a common wireless network. Furthermore, control equipment can be connected to the variable frequency drive via the wireless network.

The type of system described in U.S. Pat. No. 10,389,304 B2 does enable easy access to a certain or multiple variable frequency drives using a wireless network; the individual variable frequency drives must first be identified and assigned within the network to be able to carry out adjustment work on the drives, for example as can occur during commissioning, via the network. Therefore, in practice, a high level of specialist expertise is still required on site to carry out the corresponding adjustment work. In practice, this means engineering work that must be carried out by highly qualified experts, in particular experts trained for operating the variable frequency drives in question, on site, and is therefore correspondingly cost-intensive.

### DESCRIPTION OF VARIOUS EMBODIMENTS

The system described herein provides for commissioning variable frequency drives of electric drive systems and/or electric drive systems in which the variable frequency drive can be easily commissioned on site and in particular, also achieved by less highly trained personnel.

In connection with commissioning variable frequency drives, the wireless data transmission equipment of the variable frequency drive is set up before commissioning so that the variable frequency drive can be communicated with under an individual identifier specific to the respective variable frequency drive. During commissioning, identification of the individual variable frequency drive is carried out by the commissioning device using the identifier.

An individual identifier specific to the respective variable frequency drive is to be understood as meaning that the identifier is uniquely assigned to one variable frequency drive. The data transmission set up of the variable frequency drive can be provided in particular at the manufacturer beforehand, i.e. it is possible, for example, that the data transmission set up of the variable frequency drive is provided during manufacture of the variable frequency drive in the manufacturer's factory beforehand. It is also possible, for example, that data transmission equipment that has already been set up accordingly to be operated under specific individual identifiers, is delivered and installed in the variable frequency drive. In this case, each identifier is first clearly assigned to specific data transmission equipment. The installation of same in the respective variable frequency drive results in a clear assignment of the identifier to the respective variable frequency drive.

During commissioning, the commissioning device can clearly identify the variable frequency drive using the identifier of wireless data transmission equipment of the variable frequency drive. This ensures the secure assignment of the data to be transmitted to the respective intended variable frequency drive. This is advantageous in particular if several variable frequency drives must be put into operation during commissioning, for example of a major technical installation. Due to the unique identifiers of the data transmission equipment of the individual variable frequency drives, the commissioning device is put in a position to assign the data to be transmitted to it to each variable frequency drive and to transmit the data to the variable frequency drive in question. This makes it easier to carry out the commissioning, so that, in an ideal case, the costly use of external trained engineers can be avoided entirely, as the commissioning can be carried out by personnel on site who require only minimal instructions to do so.

The identifier can be, for example, an SSID of a wireless network according to the IEEE standards family 802.11. SSID wireless networks are referred to as Wi-Fi or WLAN networks. The use of a wireless network according to this standard offers the advantage that numerous standard components can be used as a commissioning device, for example, standard commercial laptops or tablets. In an ideal case, laptops or tablets can also be put in a position to be used as a commissioning device for the system described herein by installing the corresponding software.

The system described herein can provide for an access point of an infrastructure network to be made available by the data transmission equipment. The infrastructure network can be, for example, an infrastructure-mode operated WLAN or Wi-Fi network. In that case, the commissioning device can communicate, in the role of the client, with the wireless data transmission equipment of the variable frequency drive via an identifier of the wireless data transmission equipment, for example, an SSID of the wireless data transmission equipment.

The identifier can be selected according to the serial number of the variable frequency drive when setting up the data transmission equipment of the variable frequency drive. This allows a clear relationship to be defined between the identifier and the serial number. This may occur, for example, because the identifier contains the serial number. This type of configuration makes it possible, in particular, to identify the variable frequency drives on site on the basis of the identifiers of the corresponding data transmission equipment, even if only the serial numbers of the variable frequency drives are known. This means that the user of the commissioning device or the commissioning device itself only needs to be informed of the serial numbers, but not the identifiers, and particularly not the SSIDs of the respective networks.

Alternatively and/or additionally, the identifier can be selected in such a way that the identifier can be assigned to the serial number of the variable frequency drive in a clear way and/or the serial number can be identified using the identifier. Identification of the serial number using the identifier, can, for example, be made possible by connecting the serial number and the identifier to one another via a mathematical algorithm. This can make it possible to compute the serial number from an identifier and/or the identifier from the serial number. An assignment between identifiers and serial numbers can also be made possible via assignment tables. Depending on the respective use case, the previously mentioned options to clearly connect serial numbers and identifiers can be used, for example, to enable security and/or authentication functions. In this way, in particular the connection via mathematical algorithms can be used to make the computation of the identifier from the serial number or the serial number from the identifier more difficult, practically impossible, so that, for example, unauthorized access to the variable frequency drive via the data transmission equipment can be prevented or at least made more difficult. For example, access can be made dependent on the knowledge of a cryptographic key.

The system described herein can provide for the commissioning device to transmit data intended for an individual variable frequency drive via the data transmission equipment to this variable frequency drive after the identification of the individual variable frequency drive.

The identification of individual variable frequency drives makes it possible to clearly define which data is transmitted to which variable frequency drive during commissioning. Here, the commissioning device is set up in particular to automatically select the data intended for the respective variable frequency drive from a database. In this way, assignment errors by the personnel who carry out the commissioning on site can be avoided or even ruled out.

The data transmitted as part of the system described herein can contain programs and/or parameters, in particular for the execution of control and/or regulation tasks by the variable frequency drive.

In this context, by programs in particular sequences of instructions that cause the variable frequency drive to execute certain functions are to be understood. Programs can mean in particular programs that cause the variable frequency drive to control and/or regulate the electric motor in a certain manner.

Parameters means, in particular, value indications that have an effect on the operating method of the variable frequency drive. The value indications can be, in particular, controller parameters, for example, PID controller parameters. Alternatively and/or in addition, the parameters may be values, in particular, target values, of operating variables, such as voltage, current, speed and/or torque.

The transmitted data can alternatively and/or additionally contain WLAN settings and/or network settings, in particular, where the WLAN settings and/or network settings put the variable frequency drive in a position to register as a client in a network using the data transmission equipment. This may be advisable if, for example, the variable frequency drive is to be included in a network at a place of use of the variable frequency drive, for example, in order to integrate the variable frequency drive into a superordinate control. In this case, using the system described herein, inclusion of the variable frequency drive in a network during commissioning can easily be accomplished. In particular, the system described herein in this context can provide after the transmission of the data intended for this variable frequency drive, for the data transmission equipment to cause the variable frequency drive to automatically register in a network using the transmitted network settings.

Alternatively and/or additionally, the transmitted data may contain input/output settings. The input/output settings concern, in particular, the variable frequency drive interfaces to the actuators and/or sensors.

The system described herein can provide for data to be transmitted from the variable frequency drive to the commissioning device via the data transmission equipment. This data may be diagnostic data, in particular. Diagnostic data is to be understood, in particular, as such data that enables a fault diagnosis, in particular, the identification of a specific fault. Diagnostic data may contain a fault code, for example, for this purpose that is specific to a certain type of fault and, in the event that a fault of this type occurs, is transmitted to the commissioning device.

Alternatively and/or additionally, the diagnostic data may be status data. Status data is to be understood, in particular, as data that concerns the status of an element of the drive system, in particular, the variable frequency drive. The status may be the status of an interface of the variable frequency drive to an actuator and/or sensor. Alternatively and/or additionally, the status data may be operating data. Operating data is to be understood, in particular, as data that concerns the operation of the drive system, in particular, the variable frequency drive. This may be values, in particular, actual values, of operating variables, such as, in particular, voltage, current, speed and/or torque.

The system described herein can provide for the commissioning device to use the identifier to select the data intended for the individual variable frequency drive from a data pool that contains data intended for multiple individual variable frequency drives. The data pool can be located on a storage device of the commissioning device. Alternatively and/or additionally, it is possible that the data pool is located on an external storage device that the commissioning device accesses, for example using a remote data transmission device. The respective data in the data pool can have an identifying feature for this purpose that enables a comparison with the identifier so as to be able to assign the data from the data pool to a particular variable frequency drive. In this case, the system described herein provides for the commissioning device to carry out a comparison of the identifier with the identifying features.

The system described herein can provide for the variable frequency drive and/or a packaging of the variable frequency drive to have a tag that enables the identification of the identifier specific to each variable frequency drive. The tag can be, in particular, a machine-readable tag, such as for example a barcode or a QR code.

The system described herein can provide, for example, for the tag to be read in with a suitable reading device of the commissioning device and/or a suitable reading device that is connected to the commissioning device. The reading device can, for example, be a barcode scanner and/or a camera, in particular, for recognizing a barcode and/or QR code. This makes it possible for the commissioning device to identify the identifier of a certain variable frequency drive by reading the tag. This puts the commissioning device in a position to communicate with the variable frequency drive under a specific identifier of the variable frequency drive. This also puts the commissioning device in a position to identify the variable frequency drive during commissioning using the identifier and, in particular, to transmit the data to the variable frequency drive accordingly, even if the wireless data transmission equipment of the variable frequency drive is operated in such a way that the variable frequency drive cannot be recognized by the commissioning device without knowledge of the identifier. This may be the case, for example, if the data transmission equipment provides an access point with a deactivated SSID transmission. In this case, the network may be a so-called “hidden” network. The knowledge about the identifier allows the commissioning device to actively search for the hidden network of the wireless data transmission equipment of the variable frequency drive and connect to the hidden network.

Alternatively and/or additionally, the system described herein can provide for the tag affixed to the variable frequency drive and/or packaging of the variable frequency drive to enable the identification of the serial number of the respective variable frequency drive. In particular, when the serial number is connected to the identifier in one of the previously described manners, this can enable the automatic identification of the identifier using the serial number by the commissioning device, which can then in turn connect to the wireless data transmission equipment of the variable frequency drive.

The system described herein can, in particular, provide for the data that is transmitted from the commissioning device to the variable frequency drive to be previously transmitted to the commissioning device via a remote data transmission equipment. The remote data transmission equipment can be, in particular, the internet. This has the advantage that the data does not have to be made available on site before commissioning, for example, on a data carrier. In this context, the system described herein can in particular provide for the data to be obtained by the commissioning device automatically, provided that the commissioning device has the identifier and/or serial number of the respective variable frequency drive. In this context, the commissioning device, in particular, can access a data pool that contains data intended for multiple individual variable frequency drives using the remote data transmission equipment.

In this context, the system described herein can, in particular, provide, when the commissioning device is accessing the data pool, for the identifier and/or serial number to be transmitted to the data processing equipment that provides the data pool. Then, the set of data intended for the variable frequency drives concerned can be selected by the data processing equipment and transmitted to the commissioning device. In this way, it can be ensured that only data of the variable frequency drives that are part of the process in the specific case is transmitted to the commissioning device. In this way, for example, it can be prevented that the operator of the commissioning device obtains unauthorized knowledge about data that concerns the variable frequency drives of third parties.

Alternatively and/or additionally, the data transmitted to the commissioning device may contain information about which individual variable frequency drive the respective data is intended for. In particular, the transmitted data may be connected to the identifier of the corresponding data transmission equipment and/or the serial number of the respective variable frequency drive. This makes particular sense if, as part of the commissioning process, the data that is intended for multiple variable frequency drives is transmitted in a joint transmission process to the commissioning device. This can then “process” the commissioning of the individual variable frequency drives and at the same time select the data intended respectively for each variable frequency drive, without having to maintain the connection via the remote data transmission equipment.

The system described herein can provide for a network-compatible terminal to be set up for use as commissioning device. The network-compatible terminal may, in particular, be a personal computer, a tablet, and/or a smartphone that is set up for use as commissioning device by installing software on the terminal. These types of terminals have the advantage that they are available at low cost as mass-produced goods and are generally equipped with basic software, in particular, in the form of an operating system. In this context, a few operating systems are so widespread that many commercially available terminals that are compatible with these types of operating system can be put in a position to be used as commissioning devices in the system described herein using the corresponding software. This further simplifies commissioning on site. In the best case, the commissioning person on site will not need any physical commissioning device at all, just the corresponding software, which the user can install on the network-compatible terminal themselves on site and provide commissioning according to the system described herein.

For this purpose, the software can be transmitted to the end device using remote a data transmission equipment. The software is transmitted, in particular, via the internet. The infrastructure for providing the software via the internet is generally available, reliable standard solutions are available in particular for the specific implementation using software engineering.

The system described herein can provide that, after the transmission of the data to a certain variable frequency drive, in particular, in an automated fashion, the commissioning device searches for radio signals of further variable frequency drives each identifiable by the commissioning device using the identifier of the corresponding data transmission equipment. Here, the search may consist in a passive scan of corresponding radio frequencies; however, also active “pinging” of data transmission equipment may be provided with certain identifiers, for example, to be able to find invisible (hidden) WLANs. By this kind of implementation, user-friendliness is optimized during commissioning. In the best case, the commissioning process may only be started once, the commissioning device will search until all variable frequency drives have been found and supplied with the data intended for them.

The system described herein is suitable both for the commissioning of the variable frequency drive as such and for the commissioning of the entire electric drive system. As the variable frequency drive is typically the component of the drive system that must be supplied with data during commissioning, the system described herein for commissioning a variable frequency drive can be used to provide the commissioning for the entire drive system whose component is the variable frequency drive commissioned accordingly.

The features of the invention disclosed in the present description as well as in the claims may be essential for the realization of the invention in its various embodiments both individually and in any combination. The invention is not limited to the described embodiments. It can be varied within the scope of the claims and taking into consideration the knowledge of the relevant person skilled in the art.

1. A method for commissioning variable frequency drives of electrical drive systems, wherein at least one of the variable frequency drives has wireless data transmission equipment via which the at least one of the variable frequency drives is supplied with data during commissioning, the method comprising:
a commissioning device connecting with the wireless data transmission equipment of the at least one of the variable frequency drives during commissioning to transmit data to the at least one of the variable frequency drives;
setting up the wireless data transmission equipment of the at least one of the variable frequency drives before commissioning the at least one of the variable frequency drives so that the at least one of the variable frequency drives can be communicated with under an individual identifier specific to the at least one of the variable frequency drives; and
during commissioning of the at least one of the variable frequency drives, the commissioning device identifying the at least one of the variable frequency drives using the identifier.

2. The method according to claim 1, wherein the identifier is an SSID of a wireless network in accordance with the IEEE standards family 802.11 (WLAN).

3. The method according to claim 1, wherein the data transmission equipment provides an access point of an infrastructure network.

4. The method according to claim 1, wherein when setting up the data transmission equipment of the at least one of the variable frequency drives, the identifier is selected depending on a serial number of the at least one of the variable frequency drives.

5. The method according to claim 1, wherein, after the identifying the at least one of the variable frequency drives, the commissioning device transmitting data intended for the at least one of the variable frequency drives via the data transmission equipment to the at least one of the variable frequency drives.

6. The method according to claim 5, wherein data that is transmitted contains programs and/or parameters for execution of control and/or regulation tasks by the at least one of the variable frequency drives.

7. The method according to claim 5, wherein data that is transmitted contains settings for a network that puts the at least one of the variable frequency drives in a position to register as a client in the network via the wireless data transmission equipment.

8. The method according to claim 5, wherein the commissioning device uses the identifier to select the data intended for the at least one of the variable frequency drives from a data pool that contains data intended for multiple ones of the variable frequency drives.

9. The method according to claim 1, wherein the at least one of the variable frequency drives and/or packaging of the at least one of the variable frequency drives has a tag that enables identification of the identifier corresponding to the at least one of the variable frequency drives and/or a serial number of the at least one of the variable frequency drives.

10. The method according to claim 1, wherein data that is transmitted from the commissioning device to the at least one of the variable frequency drives is previously transmitted to the commissioning device using remote data transmission equipment.

11. The method according to claim 1, wherein data transmitted to the commissioning device contains information about particular ones of the variable frequency drives for which the data is intended.

12. The method according to claim 1, wherein the commissioning device is a network-compatible terminal.

13. The method according to claim 12, wherein software is transmitted to the network-compatible terminal via remote data transmission equipment.

14. The method according to claim 5, wherein after transmission of the data to the at least one of the variable frequency drives, the commissioning device searches for radio signals of other ones of the variable frequency drives that are each identifiable by the commissioning device using an identifier of the data transmission equipment corresponding to each of the other ones of the variable frequency drives.

15. A method for the commissioning of an electric drive system having a variable frequency drive and an electric motor that is supplied with electrical energy using the variable frequency drive, the method comprising:
commissioning the variable frequency drive by the following:
connecting a commissioning device with wireless data transmission equipment of the variable frequency drive during commissioning to transmit data to the variable frequency drive;
setting up the wireless data transmission equipment of the variable frequency drive before commissioning the variable frequency drive so that the variable frequency drive can be contacted using an individual identifier specific to the variable frequency drive; and
during commissioning of the variable frequency drive, the commissioning device identifying the variable frequency drive using the identifier.

16. The method according to claim 4, wherein the serial number is the identifier and/or the serial number can be identified using the identifier.

17. The method according to claim 9, wherein the tag is one of: a barcode or QR code.

18. The method according to claim 10, wherein the data is transmitted using the internet.

19. The method according to claim 11, wherein the data transmitted to the commissioning device contains information indicative of at least one of: identifiers for the particular ones of the variable frequency drives for which the data is intended or serial numbers for the particular ones of the variable frequency drives for which the data is intended.

20. The method according to claim 12, wherein the network-compatible terminal is one of: a PC, tablet or a smartphone.

21. The method according to claim 13, wherein the software is transmitted via the internet.
